(19) United States
(12) Patent Application Publication
(10) Pub. No.: US 2017/0165983 A1
(43) Pub. Date: Jun. 15, 2017

(54) PRINT APPARATUS

(71) Applicant: SEIKO EPSON CORPORATION, Tokyo (JP)

(72) Inventors: Yoji TAKAHASHI, Matsumoto (JP); Eiji KUMAI, Matsumoto (JP)

(21) Appl. No.: 15/379,244

(22) Filed: Dec. 14, 2016

(30) Foreign Application Priority Data
Dec. 15, 2015 (JP) 2015-243865

(51) Int. Cl. B41J 11/58

(52) U.S. Cl. CPC B41J 11/58

(57) ABSTRACT

In a print apparatus including a first holder unit that holds a rolled medium, the first holder unit includes a base, a main shaft that is supported on the base and moves along an axial direction to thereby fix the rolled medium, a split-nut portion that is provided on the base and is splittable into two, a bolt that moves the main shaft along the axial direction, a handle that rotates the bolt, and an opening/closing mechanism that opens and closes the split-nut portion. The split-nut portion is screwed onto the bolt and moves the bolt rotated with the handle along the axial direction while the split-nut portion is closed, and releases the bolt while the split-nut portion is open.

### BACKGROUND

1. Technical Field

The present invention relates to a print apparatus.

2. Related Art

A known large print apparatus has a so-called roll-to-roll configuration in which a recording medium is supplied in a rolled form and a printed recording medium is wound into a roll and is collected. Such a print apparatus includes medium supports that support both sides of a rolled medium. JP-A-2013-32206, for example, describes a print apparatus that presses a rolled medium from one side to the other to fix the rolled medium by user's rotation of a handle provided to one of roll medium holder devices (medium supports).

### SUMMARY

In the print apparatus of JP-A-2013-32206, however, to exchange rolled media, a user needs to rotate the handle in a direction opposite to the direction in attachment to return the medium supports to an initial state. That is, to exchange rolled media in the known print apparatus, the user expends effort to exchange the rolled media.

An advantage of some aspects of the invention is to solve at least a part of the problems described above, and can be obtained in the following embodiments or aspects.

### [First Aspect]

A print apparatus according to an aspect is a print apparatus including a medium support that holds a rolled medium. The medium support includes a base that moves along an axial direction of a guide rail and is fixed to the guide rail, a main shaft that is supported on the base and moves along the axial direction to thereby fix the rolled medium, a split-nut portion that is provided on the base and is splittable into two, a bolt that moves the main shaft along the axial direction, a handle that rotates the bolt axially, and an opening/closing mechanism that opens and closes the split-nut portion, and the split-nut portion is screwed onto the bolt and moves the bolt rotated with the handle along the axial direction while the split-nut portion is closed, and releases the bolt while the split-nut portion is open.

In this aspect, the medium support of the print apparatus includes a split-nut portion and an opening/closing mechanism that opens and closes the split-nut portion. The split-nut portion is screwed onto the bolt and moves the bot rotated with the handle along the axial direction while the split-nut portion is closed. In addition, the bolt moves the main shaft along the axial direction so that the rolled medium is fixed to the medium support. While the split-nut portion is open, the split-nut portion releases the bolt onto which the split-nut portion is screwed. In this manner, the bolt and the handle provided to the bolt can be freely moved along the axial direction relative to the split-nut portion connected to the base. In other words, by opening the split-nut portion using the opening/closing mechanism in exchanging rolled media, a user can return the medium support to an initial position without rotating the handle. Thus, efficiency in exchanging rolled media can be enhanced. As a result, it is possible to provide a print apparatus having enhanced efficiency in exchanging rolled media.

### [Second Aspect]

The print apparatus of the above aspect preferably includes an elastic member that returns the bolt to an initial position when the split-nut portion is unscrewed from the bolt.

In this aspect, with the medium support, when the split-nut portion is unscrewed from the bolt, the bolt and the handle connected to the bolt return to initial positions by an elastic force of the elastic member. Thus, efficiency in exchanging rolled media can be further enhanced.

### [Third Aspect]

In the print apparatus of the above aspect, the opening/closing mechanism preferably includes an opening/closing roller that is connected to the split-nut portion and opens and closes the split-nut portion, an arm that is engaged with the opening/closing roller and moves along the axial direction to thereby open or close the opening/closing roller, and an elastic member that moves the arm along the axial direction.

In this aspect, the opening/closing mechanism includes the elastic member that moves the arm to be engaged with the opening/closing roller for opening or closing the split-nut portion along the axial direction. By moving the arm along the axial direction using an elastic force of the elastic member when the rolled medium is unfixed, the split-nut portion can be opened using the opening/closing roller.

### [Fourth Aspect]

In the print apparatus of the above aspect, the opening/closing mechanism preferably includes an elastic member that keeps the split-nut portion closed, and a button that opens the split-nut portion.

In this aspect, since the opening/closing mechanism is constituted by a small number of components including the elastic member keeping the split-nut portion in the closed state and the button, the opening/closing mechanism for opening/closing the split-nut portion can be obtained at low costs.

### BRIEF DESCRIPTION OF THE DRAWINGS

The invention will be described with reference to the accompanying drawings, wherein like numbers reference like elements.

FIG. 1 is a cross-sectional side view schematically illustrating a configuration of a print apparatus according to an embodiment.

FIG. 2 is a rear view schematically illustrating the configuration of the print apparatus.

FIG. 3 is a perspective view illustrating a feeder.

FIG. 4 is a side view illustrating the feeder in an enlarged manner.

FIG. 5 is a side view illustrating the feeder in an enlarged manner.

FIG. 6 is a side view illustrating a split-nut portion in FIG. 5 in an enlarged manner.

FIG. 7 is a plan view illustrating an opening/closing mechanism in FIG. 5 in an enlarged manner.

FIG. 8 is a side view illustrating the feeder in an enlarged manner.

FIG. 9 is a side view illustrating the split-nut portion in FIG. 8 in an enlarged manner.

FIG. 10 is a plan view illustrating the opening/closing mechanism in FIG. 8 in an enlarged manner.

FIG. 11 is a side view illustrating the feeder in an enlarged manner.

FIG. 12 is a side view illustrating the feeder in an enlarged manner.

FIG. 13 is a side view illustrating a split-nut portion according to a variation in an enlarged manner.

### DESCRIPTION OF EXEMPLARY EMBODIMENTS

An embodiment of the present invention will be described hereinafter with reference to the drawings. In the drawings, dimensions of members are different from those of actual members so that the members have recognizable sizes.

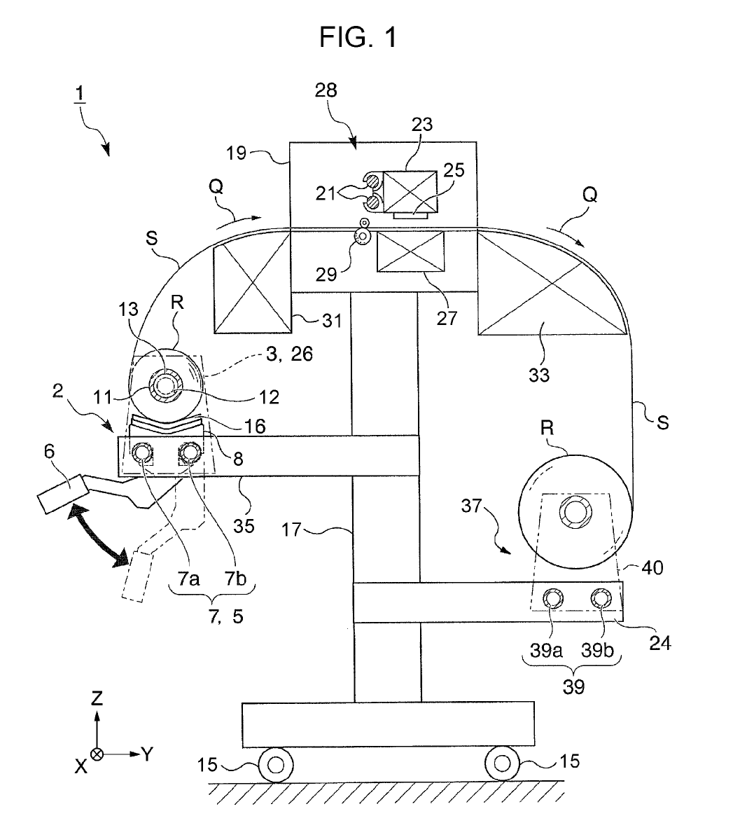

FIGS. 1 through 13 use an X axis, a Y axis, and a Z axis as three perpendicularly intersecting axes for convenience of description. A distal end of an arrow indicating each axis is defined as a “+side” and a proximal end thereof is defined as a “− side.” A direction parallel to the X axis is defined as an “X axis direction,” a direction parallel to the Y axis is defined as a “Y-axis direction,” and a direction parallel to the Z axis is defined as a “Z-axis direction.”

### Embodiment

First, a configuration of a print apparatus will be described. The print apparatus is, for example, an ink jet printer. In this embodiment, a large format printer (LFP) using a relatively large-size medium will be described as an example of the configuration of the print apparatus.

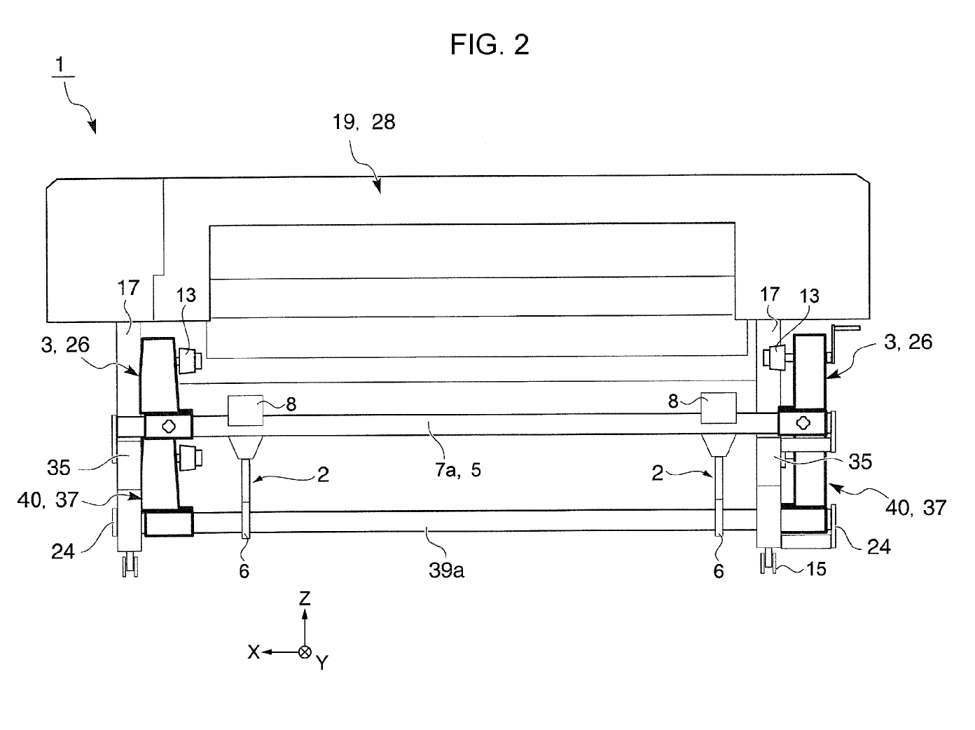

FIG. 1 is a cross-sectional side view schematically illustrating a configuration of a print apparatus according to the embodiment. FIG. 2 is a rear view schematically illustrating the configuration of the print apparatus. As illustrated in FIGS. 1 and 2, a print apparatus 1 includes, for example, a pair of legs 17 each having a bottom end provided with a caster 15 for moving the print apparatus 1 and a recording casing 19 mounted on the legs 17. The print apparatus 1 also includes, for example, a feeder 26 that feeds a recording medium S from a rolled medium R that is wound into a roll shape, a recording unit 28 that records an image, for example, on the recording medium S, and a winder 37 that winds the recording medium S. In this embodiment, a vertical direction along a direction of gravity is the Z axis. An axial direction (width direction) of the rolled medium R intersecting (perpendicularly intersecting in this embodiment) the Z axis is the X axis. A direction intersecting (perpendicularly intersecting in this embodiment) both the Z axis and the X axis (front/rear direction) is the Y axis, the +Y axis side is “front,” and the −Y axis side is “rear.”

The feeder 26 unwinds the recording medium S from the rolled medium R and feeds the recording medium S in a conveying direction Q. Specifically, the feeder 26 is provided at the rear (−Y axis side) of the print apparatus 1, and is supported by the legs 17 through a retainer 35. The feeder 26 includes first holder units 3 serving as medium supports that are feed-side roll holders supporting the rolled medium R.

The first holder units 3 are a pair of opposed holder units and hold both ends of the rolled medium R so that the rolled medium R can rotate. Each of the first holder units 3 includes a fitting portion 13 that fits into a core opening 12 of a roll core 11 of the rolled medium R. The fitting portion 13 has a substantially truncated conical shape so that the fitting portion 13 can be easily fit into the core opening 12. The fitting portion 13 may be freely rotatable or may be driven by power of an unillustrated motor. In the case where the fitting portion 13 is freely rotatable, the recording medium S is conveyed downstream in the conveying direction Q by driving a roller pair 29 disposed upstream in the recording unit 28 and configured to pinch the recording medium S in the recording casing 19 so that the recording medium S is unwound from the rolled medium R. The roller pair may be disposed downstream in the recording unit 28, at each side of the recording unit 28, or outside the recording casing 19.

At least one of the pair of first holder units 3 is moveable along the axial direction of a guide rail 7 extending along the X axis direction, and the attachment position of the first holder unit 3 is changeable. The guide rail 7 is constituted by a first pipe member 7a and a second pipe member 7b both having pipe shapes and extending in parallel along the X axis direction, and is supported at both ends by the retainer 35. The guide rail 7 also serves as a temporary placing base 5, which will be described later.

The temporary placing base 5 serving as a temporary base unit and a medium elevation unit 2 are disposed below the first holder units 3. The temporary placing base 5 is a base on which the rolled medium R is temporarily placed before being attached to the first holder units 3. As one example, the temporary placing base 5 may be constituted by two pipe members of the first pipe member 7a and the second pipe member 7b extending in the X axis direction.

The medium elevation unit 2 is a so-called elevation device, and elevates the rolled medium R having a large mass from the temporary placing base 5 so that the core opening 12 of the rolled medium R and the fitting portions 13 of the first holder units 3 are located substantially at the same height. In this manner, a user can easily hold the rolled medium R on the first holder units 3. More specifically, the medium elevation unit 2 includes a base body 8 slidable along the X axis direction relative to the first pipe member 7a and the second pipe member 7b, an operating lever 6, and an elevation portion 16. When the operating lever 6 is rotated in one direction, the elevation portion 16 ascends and can lift the rolled medium R. When the operating lever 6 is rotated in the opposite direction, the elevation portion 16 descends and can lower the rolled medium R. The medium elevation unit 2 is configured based on the principle of leverage, and the rolled medium R having a large mass can be moved up and down by a small force.

The recording unit 28 is disposed in the recording casing 19. The recording unit 28 includes a carriage guide shaft 21 extending in the X axis direction, a carriage 23, a recording head 25, and the medium support 27. The carriage 23 can reciprocate along the width direction of the recording medium S (X axis direction) while being guided by the carriage guide shaft 21. The recording head 25 is mounted on the carriage 23 to face the medium support 27, and ejects ink or other liquid substances toward the recording medium S while reciprocating. In this manner, an image or the like is recorded on the recording medium S. The medium support 27 supports the recording medium S, and keeps the distance between the recording medium S and the recording head 25 at a predetermined distance. In this embodiment, the recording head 25 is of a serial head type that is mounted on the reciprocating carriage 23 and ejects ink while moving along the width direction of the recording medium S (X axis direction), as an example. Alternatively, the recording head 25 may be of a line head type that extends along the width direction of the recording medium S (X axis direction) and is fixed in this arrangement.

In the conveying direction Q of the recording medium S, a preheater 31 is disposed upstream of the recording casing 19. In a stage before recording on the recording medium S, the recording medium S is heated beforehand so that ink attached to the recording medium S can be easily dried in perform recording. An after heater 33 is disposed downstream of the recording casing 19. In this manner, ink attached to the recording medium S can be dried from the recording unit 28 to the winder 37.

The winder 37 winds the recording medium S into a roll and holds the recording medium S as the rolled medium R. Specifically, the winder 37 is disposed at the front (+Y axis side) of the print apparatus 1, and is supported by the legs 17 through the retainer 24. The winder 37 includes second holder units 40 as medium supports that are winding roll holders. The second holder units 40 are provided in pair and opposed to each other. At least one of the pair of second holder units 40 is moveable along the axial direction of a guide rail 39 extending along the X axis direction, and the attachment positions of the second holder units 40 are changeable. The guide rail 39 is constituted by a third pipe member 39a and a fourth pipe member 39b having pipe shapes and extending in parallel along the X axis direction. One of the pair of second holder units 40 is provided with an unillustrated motor, and the recording medium S is wound into a roll by driving the motor.

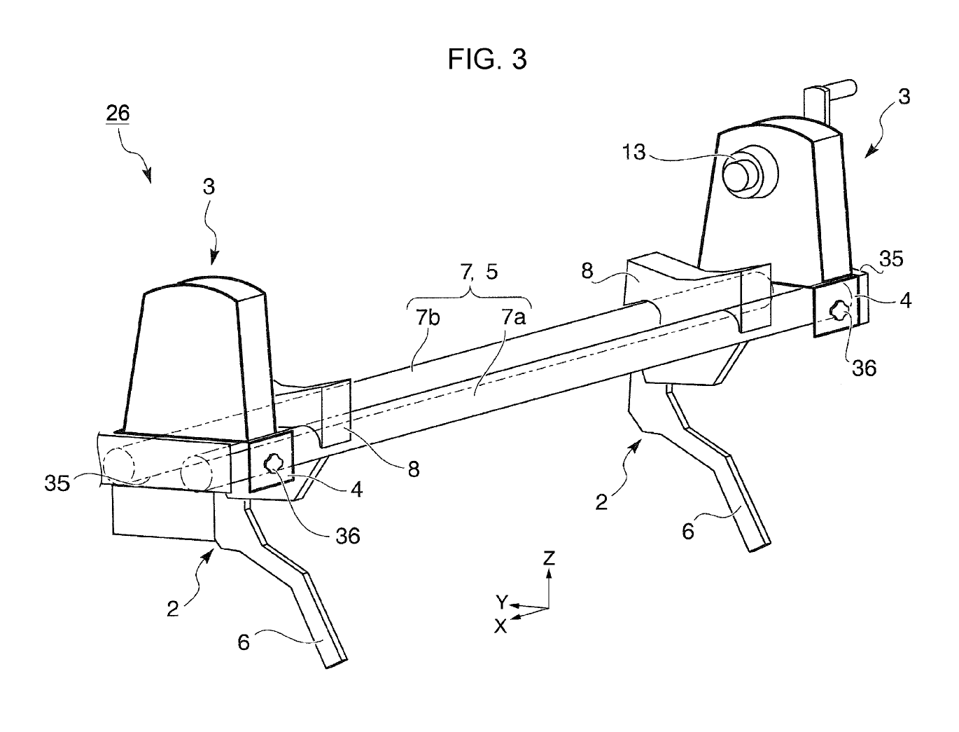

FIG. 3 is a perspective view illustrating a feeder. Referring now to FIG. 3, a configuration for fixing the first holder units 3 to the guide rail 7 will be described. A configuration for fixing the second holder units 40 to the guide rail 39 is the same as the configuration for fixing the first holder units 3 to the guide rail 7, and thus, description thereof will not be repeated.

As illustrated in FIG. 3, the first holder units 3 as medium supports move along the axial direction of the guide rail 7 (X axis direction), and each includes a base 4 to be fixed on the guide rail 7. Specifically, the base 4 constitutes a frame of the corresponding first holder unit 3, and enables the entire first holder unit 3 to move relative to the guide rail 7. The base 4 has a through hole (not shown) formed to penetrate a lower portion of the base 4 (at the −Z axis side) in the X axis direction and conforming to the shape of the first or second pipe member 7a or 7b. The first holder unit 3 stands on the first or second pipe member 7a or 7b.

The base 4 has a through hole (not shown) formed along the Y-axis direction and communicating with the through hole of the first pipe member 7a. An internal screw is provided on the inner wall of the through hole. The base 4 includes an external screw that is screwed onto the internal screw and includes a knob 36. The first holder unit 3 is fixed to the guide rail 7 by rotating the knob 36 and bringing the distal end of the external screw into contact with the first pipe member 7a. The first holder unit 3 can move (slide) relative to the guide rail 7 by rotating the knob 36 to separate the distal end of the external screw from the first pipe member 7a or the second pipe member 7b. In this manner, the first holder unit 3 can hold the rolled medium R and exchange rolled media R having different widths (dimensions in the X axis direction). The distal end of the external screw may contact the first pipe member 7a or the second pipe member 7b with an intermediate member interposed therebetween.

An internal configuration of the first holder units 3 and attachment/detachment of the rolled medium R according to this embodiment will be described.

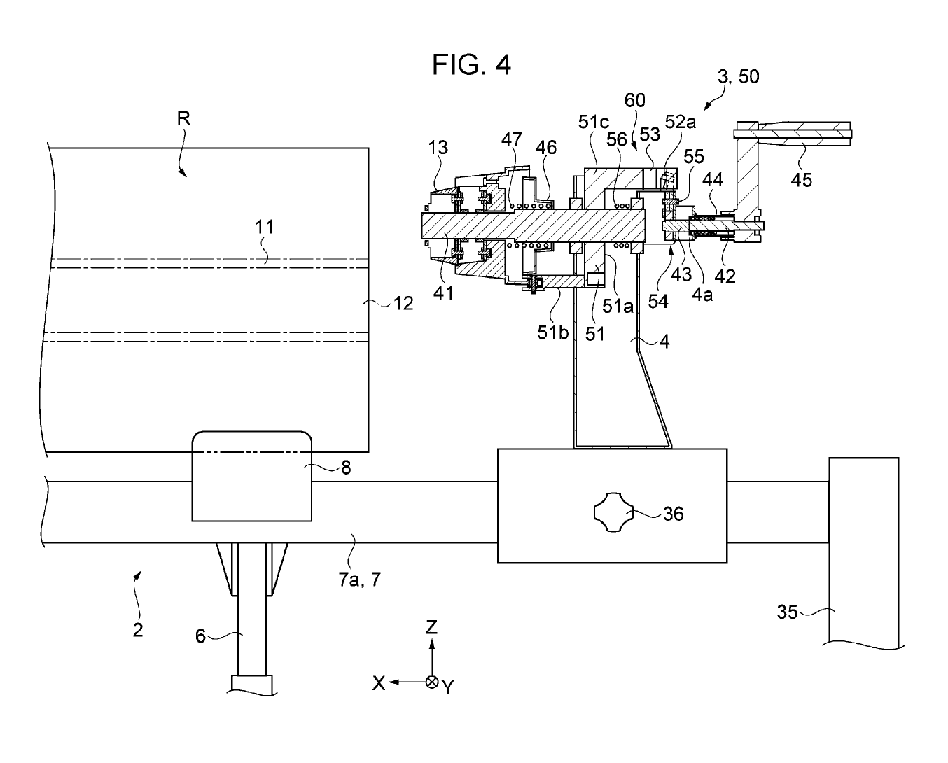

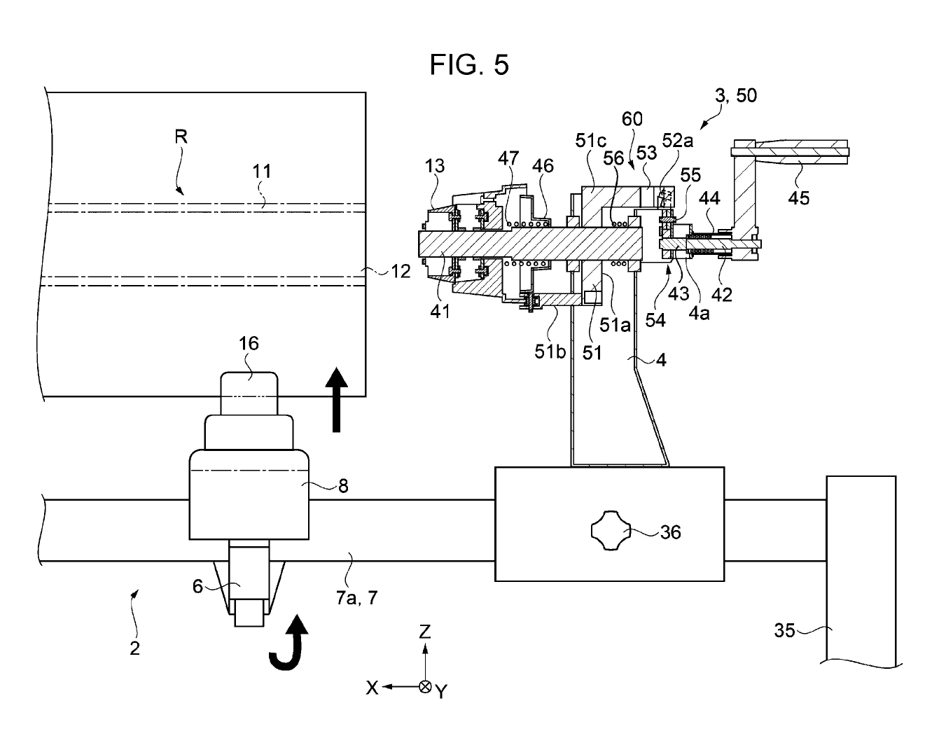

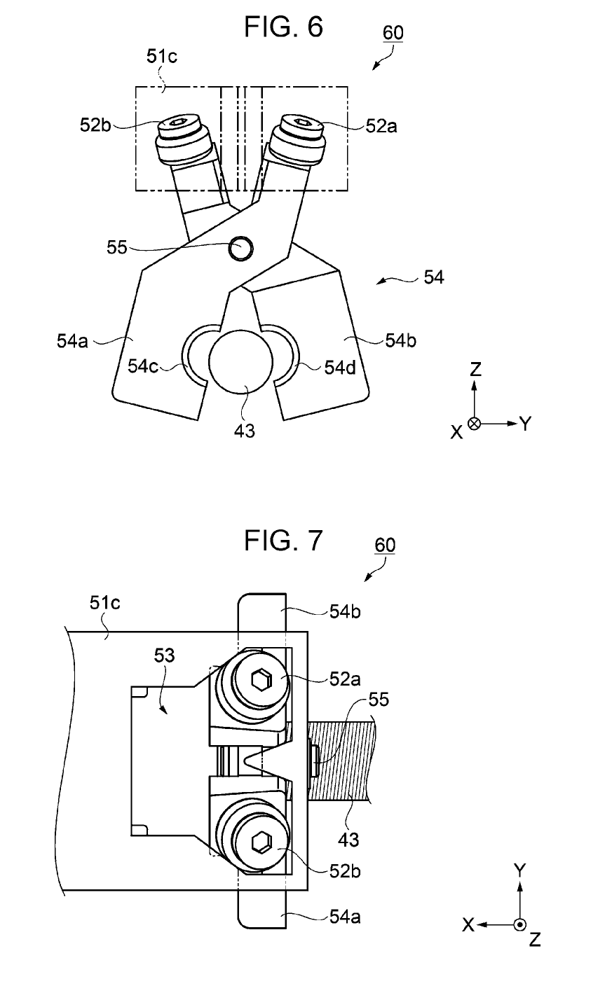

FIGS. 4 and 5 are side views illustrating the feeder in an enlarged manner. FIG. 6 is a side view illustrating the split-nut portion in FIG. 5 in an enlarged manner. FIG. 7 is a plan view illustrating an opening/closing mechanism in FIG. 5 in an enlarged manner. The feeder illustrated in FIGS. 4 and 5 is viewed from the rear side of the print apparatus 1, and a peripheral portion around one of the first holder units 3 at the right (at the −X axis side) in the drawing sheet of FIG. 2 is illustrated in an enlarged manner. A cross section of the first holder unit 3 is illustrated in FIGS. 4 and 5 to describe the internal configuration thereof. FIG. 6 illustrates the split-nut portion when viewed from the −X axis side. FIG. 7 illustrates the opening/closing mechanism when viewed from the +Z axis side. In the following description, the first holder unit located at the −X axis side will be referred to as “−X axis-side first holder unit” and the first holder unit located at the +X axis side will be referred to as “+X axis-side first holder unit.”

FIG. 4 illustrates a state in which the rolled medium R is temporarily placed on the temporary placing base 5 of the feeder 26. The fitting portion 13 of the +X axis-side first holder unit 3 that constitutes a pair with the −X axis-side first holder unit 3 illustrated in FIG. 4 is fitted into the core opening 12 at the +X axis side of the medium R. Thereafter, the rolled medium R is elevated in order to fit the fitting portion 13 of the −X axis-side first holder unit 3 into the core opening 12 at the −X side of the rolled medium R. When a user lifts the operating lever 6 toward the +Z axis side, the rolled medium R is ascended so that the core opening 12 and the fitting portion 13 are substantially at the same height. FIG. 5 illustrates this state.

The internal configuration of the first holder units 3 will now be described. As illustrated in FIGS. 4 and 5, at least one of the pair of first holder units 3 includes a side pressure mechanism 50 for applying a side pressure to the rolled medium R. The first holder unit 3 including the side pressure mechanism 50 includes a main shaft 41 that is supported on the base 4 and moves along the axial direction of the guide rail (X axis direction) to thereby fix the rolled medium R. Specifically, the main shaft 41 has a cylindrical shape extending along the X axis direction and is slidably supported on the base 4. The distal end of the main shaft 41 at the +X axis side is provided with the fitting portion 13 that is fitted into the roll core 11 of the rolled medium R and is slidable relative to the main shaft 41. The main shaft 41 is provided with a spring bearing 46 that is disposed between the fitting portion 13 and the base 4 and moves together with the main shaft 41. A coil spring (hereinafter referred to as a fitting spring 47) serving as an elastic member is provided around the main shaft 41 between the fitting portion 13 and the spring bearing 46. When the spring bearing 46 moves in the +X axis direction together with the main shaft 41, the fitting spring 47 is compressed so that a force is applied to the fitting portion 13 in the +X axis direction.

The first holder unit 3 includes a bolt 42 for moving the main shaft 41 in the axial direction, and a handle 45 for rotating the bolt 42 axially. The bolt 42 has a cylindrical shape extending along the X axis direction. An external screw portion 43 is provided at the distal end of the bolt 42 at the +X axis side. The proximal end of the bolt 42 is provided with a handle 45 for rotating the bolt 42 around the X axis. The bolt 42 is supported on the base 4 through the retainer 4a. The main shaft 41 and the bolt 42 are disposed to have their center axes substantially coincide with each other. In a state where the external screw portion 43 is screwed into a split-nut portion 54 described later provided to the base 4 and the distal end of the bolt 42 and the proximal end of the main shaft 41 are in contact with each other, when the handle 45 rotates in one direction so that the bolt 42 moves in the +X axis direction, the main shaft 41 can be moved in the +X axis direction.

The first holder unit 3 includes the split-nut portion 54 that is provided on the base 4 and can be split into two. As illustrated in FIG. 6, the split-nut portion 54 has a configuration in which a pair of stays 54a and 54b whose distal ends are engaged with each other are joined together by a fixing shaft 55 so that the distal ends can be opened and closed. The distal ends (−Z axis sides) of the stays 54a and 54b are provided with two nut pieces 54c and 54d obtained by splitting. The split-nut portion 54 functions as one nut having an internal screw on an inner periphery thereof when the pair of stays 54a and 54b is closed at the other ends (at the +Z axis side) and the nut pieces 54c and 54d at the distal ends meet (in a closed state). A configuration including such a nut will be hereinafter referred to as the split-nut portion 54. The split-nut portion 54 is fixed to the base 4 by the fixing shaft 55 through the retainer 4a. The split-nut portion 54 is screwed onto the external screw portion 43 of the bolt 42 to move the bolt 42 rotated with the handle 45 along the axial direction (+X axis direction) while the split-nut portion 54 is closed, and releases the external screw portion 43 of the bolt 42 while the split-nut portion 54 is open. The split-nut portion 54 illustrated in FIG. 6 is in the open state.

The first holder unit 3 includes an opening/closing mechanism 60 for opening/closing the split-nut portion 54. In addition, the opening/closing mechanism 60 includes opening/closing rollers 52a and 52b that are connected to the split-nut portion 54 to open and close the split-nut portion 54 and an arm 51 that is engaged with the opening/closing rollers 52a and 52b and moves along the axial direction (X axis direction) to thereby open or close the opening/closing rollers 52a and 52b. As illustrated in FIG. 6, each of the opening/closing rollers 52a and 52b has a cylindrical shape having a bottom surface and a top surface along the Z-axis direction. The stay 54a having the nut piece 54c at the distal end thereof is provided with the opening/closing roller 52a at the proximal end thereof. The stay 54b having the nut piece 54d at the distal end thereof is provided with the opening/closing roller 52b at the proximal end thereof. The opening/closing roller 52a and the opening/closing roller 52b are disposed along the Y-axis direction.

As illustrated in FIGS. 4 and 5, the arm 51 is constituted by a column 51a extending along the Z-axis direction and slidable along the X axis direction relative to the main shaft 41, a bar 51b connecting a lower end of the column 51a to the fitting portion 13, and an extension 51c extending from an upper end of the column 51a in the −X axis direction. As illustrated in FIG. 7, a distal end of the extension 51c has a through groove 53 to be engaged with the opening/closing rollers 52a and 52b disposed along the Y-axis direction. The through groove 53 has a substantially Y-shape that is open to the −X axis direction. The opening/closing rollers 52a and 52b slidable along the Y-shaped groove are engaged with the Y-shaped through groove 53.

For example, when the arm 51 moves in the −X axis direction relative to the opening/closing rollers 52a and 52b, the opening/closing rollers 52a and 52b move along the groove of the through groove 53 from the open side of the Y shape (−X axis side) to the closed side of the Y-shape (+X axis side). In this manner, when the distance between the opening/closing roller 52a and the opening/closing roller 52b decreases so that the closed state is established (see FIG. 10), the split-nut portion 54 is closed and is screwed onto the external screw portion 43 of the bolt 42. On the other hand, when the arm 51 moves in the +X axis direction relative to the opening/closing rollers 52a and 52b, the opening/closing rollers 52a and 52b move along the through groove 53 from the closed side of the Y-shape (+X axis side) to the open side of the Y-shape (−X axis side). In this manner, when the distance between the opening/closing roller 52a and the opening/closing roller 52b increases so that the open state is established, the split-nut portion 54 is opened and is unscrewed from the external screw portion 43 of the bolt 42.

The opening/closing mechanism 60 includes an elastic member for moving the arm 51 along the X axis direction. As illustrated in FIGS. 4 and 5, a coil spring (hereinafter referred to as an arm spring 56) serving as an elastic member is provided around the main shaft 41 between the column 51a of the arm 51 and the base 4. In this embodiment, the arm spring 56 is provided between a side wall of the column 51a at the −X axis side and an inner wall of the base 4 at the −X axis side. While the arm spring 56 is compressed, the arm spring 56 moves the arm 51 in the +X axis direction relative to the base 4.

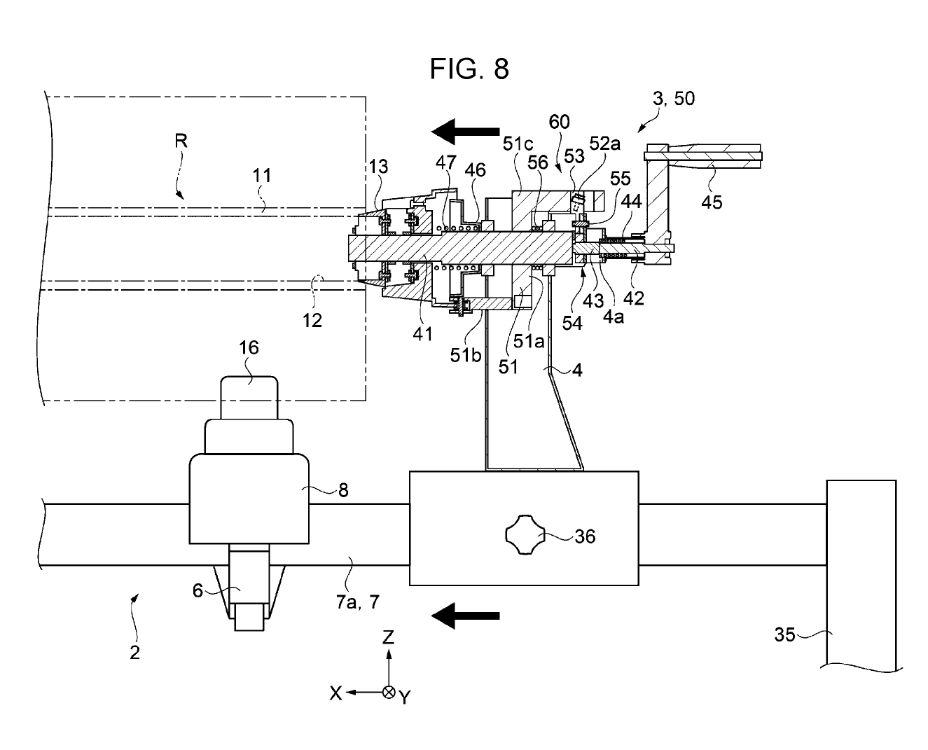

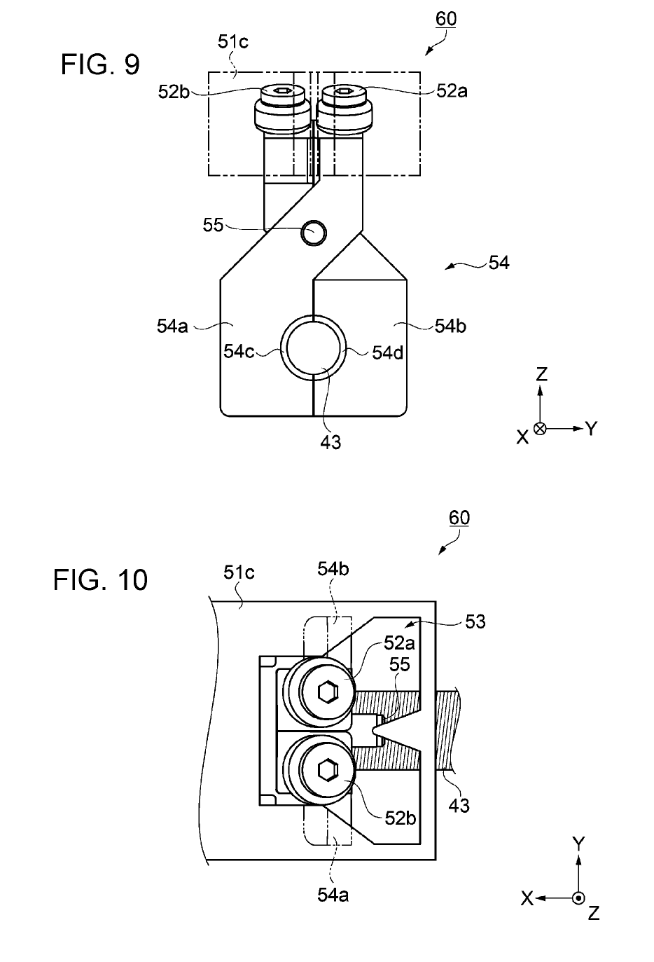

Attachment/detachment of the rolled medium R will now be described. FIG. 8 is a side view illustrating the feeder in an enlarged manner. FIG. 9 is a side view illustrating the split-nut portion in FIG. 8 in an enlarged manner. FIG. 10 is a plan view illustrating the opening/closing mechanism in FIG. 8 in an enlarged manner. In the feeder illustrated in FIG. 8, a portion around the −X axis-side first holder unit is enlarged. A cross section of the first holder unit is illustrated in FIG. 8 to describe the internal configuration thereof. FIG. 9 illustrates the split-nut portion when viewed from the −X axis side. FIG. 10 illustrates the opening/closing mechanism when viewed from the +Z axis side.

FIG. 8 illustrates a state in which the first holder unit 3 is lightly fitted into the rolled medium R. A user slides (moves) the first holder unit 3 in the state illustrated in FIG. 5 toward the rolled medium R, and lightly fits the fitting portion 13 of the first holder units 3 into the core opening 12 of the rolled medium R. In this state, the user rotates the knob 36 so that the first holder unit 3 is fixed to the guide rail 7.

More specifically, when the user moves the first holder unit 3 toward the rolled medium R (toward the +X axis side) using the base 4, the fitting portion 13 contacts the core opening 12 so that movement of the fitting portion 13 and the arm 51 connected to the fitting portion 13 in the +X axis direction stops. When the user further moves the base 4 in the +X axis direction, the base 4 and the split-nut portion 54 connected to the base 4, the opening/closing rollers 52a and 52b, the bolt 42, and the handle 45 move in the +X axis direction relative to the fitting portion 13 and the arm 51. In this manner, as illustrated in FIGS. 9 and 10, when the opening/closing rollers 52a and 52b move along the Y-shaped through groove 53 from the open side of the Y-shape (−X axis side) to the closed side of the Y-shape (+X axis side) so that the opening/closing rollers 52a and 52b and the split-nut portion 54 are closed and the split-nut portion 54 (nut pieces 54c and 54d) is screwed onto the external screw portion 43 of the bolt 42. In this state, the first holder unit 3 is fixed to the guide rail 7. At this time, the arm spring 56 between the arm 51 and the base 4 is compressed, and the arm 51 is fixed under application of a pressure to the base 4 in the +X axis direction.

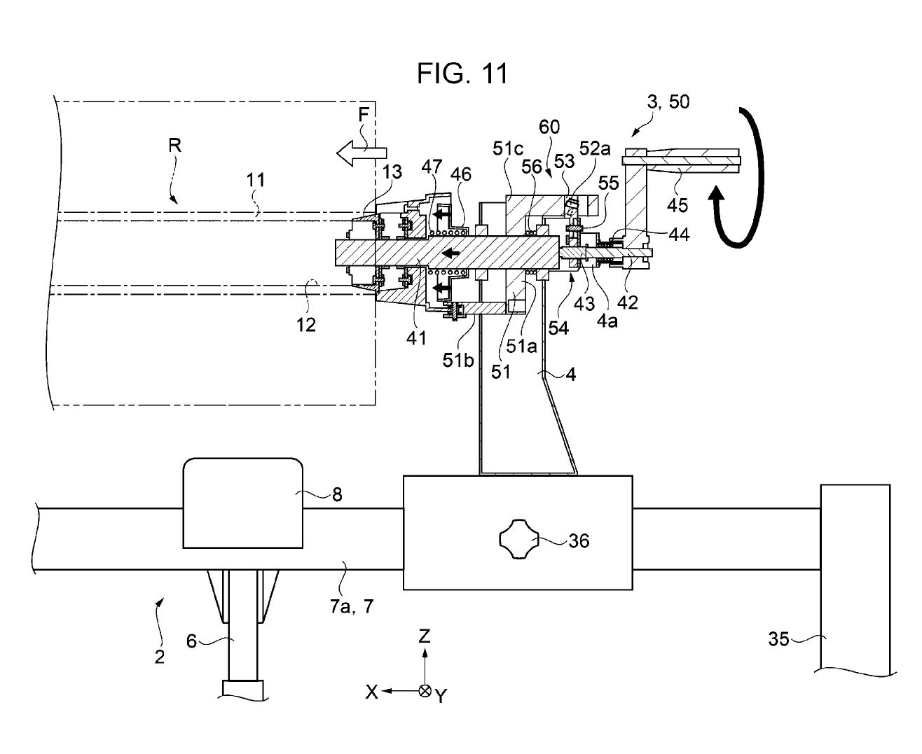

FIG. 11 is a side view illustrating the feeder in an enlarged manner. In the feeder illustrated in FIG. 11, a portion around the −X axis-side first holder unit is enlarged. A cross section of the first holder unit is illustrated in FIG. 11 to describe the internal configuration thereof.

FIG. 11 illustrates a state in which the first holder unit 3 is fixed to the rolled medium R under application of a side pressure. The user rotates the handle 45 in such a direction that the handle 45 moves the bolt 42 in the state in FIG. 8 in the +X axis direction. When the main shaft 41 is pushed by the bolt 42 in the +X axis direction, the main shaft 41 slides relative to the base 4 and the fitting portion 13, and moves to the +X axis side together with the spring bearing 46. In this manner, the fitting spring 47 between the fitting portion 13 and the spring bearing 46 is compressed so that a side pressure F in the +X axis direction is applied to the rolled medium R through the fitting portion 13, and the rolled medium R is fixed between the pair of first holder units 3.

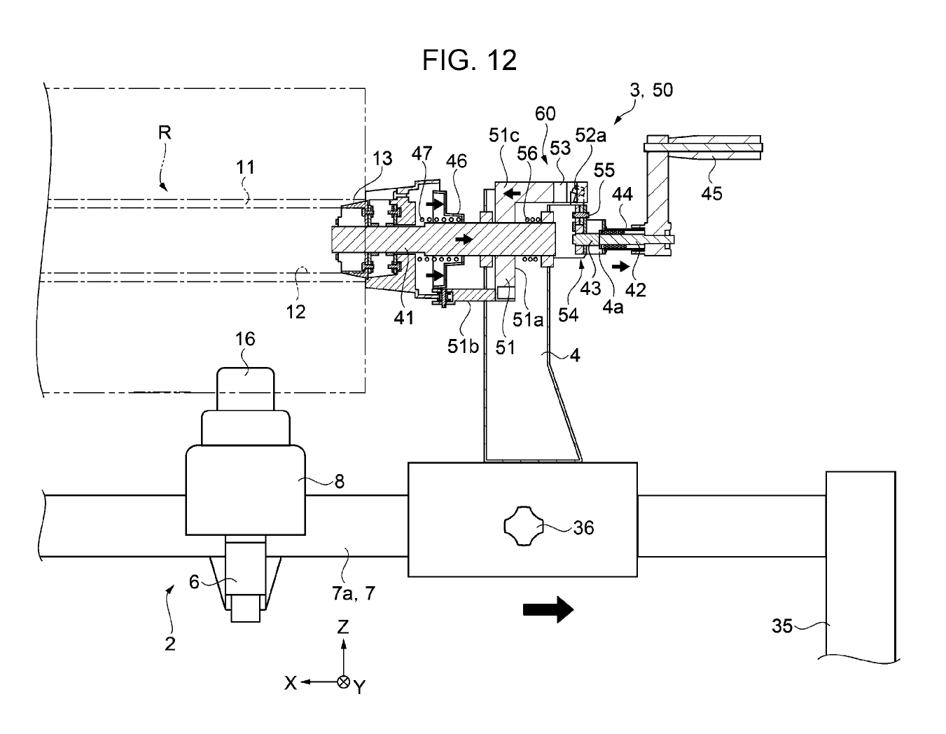

FIG. 12 is a side view illustrating the feeder in an enlarged manner. In the feeder illustrated in FIG. 12, a portion around the −X axis-side first holder unit is enlarged. A cross section of the first holder unit is illustrated in FIG. 12 to describe the internal configuration thereof.

FIG. 12 illustrates a state in which a side pressure to the rolled medium R is canceled. The user rotates the knob 36 in the state illustrated in FIG. 11 so that the first holder units 3 become slidable relative to the guide rail 7. In this manner, the compressed fitting spring 47 extends so that the main shaft 41 moves together with the spring bearing 46 in the −X axis direction relative to the fitting portion 13. Thereafter, when the bolt 42 is pushed by the main shaft 41 in the −X axis direction so that the base 4 moves in the −X axis direction and the side pressure to the rolled medium R is canceled. In addition, the extension of the compressed arm spring 56 causes the arm 51 to move in the +X axis direction relative to the base 4. At this time, the opening/closing rollers 52a and 52b move along the Y-shaped through groove 53 from the closed side of the Y-shape (+X axis side) to the open side of the Y-shape (−X axis side) so that the opening/closing rollers 52a and 52b and the split-nut portion 54 are opened, and the split-nut portion 54 is unscrewed from the external screw portion 43 of the bolt 42 (see FIGS. 6 and 7). In this manner, the bolt 42 (handle 45) becomes freely moveable along the X axis direction relative to the base 4. The user can return the bolt 42 to a predetermined position (initial position for attaching the rolled medium R, see FIG. 5) without rotating the handle 45 so that efficiency in exchanging rolled media R can be enhanced.

Furthermore, a coil spring (hereinafter referred to as a handle spring 44) serving as an elastic member for returning the bolt 42 to a predetermined position when the split-nut portion 54 is unscrewed from the external screw portion 43 of the bolt 42 is provided around the axis of the bolt 42 between the retainer 4a and the handle 45. Specifically, the handle spring 44 is compressed (see FIG. 11) when the user rotates the handle 45 to move the bolt 42 toward the +X axis side so that a side pressure is applied to the rolled medium R, from the state where the first holder units 3 are lightly fitted into the rolled medium R (see FIG. 8). When the split-nut portion 54 is unscrewed from the external screw portion 43 of the bolt 42, the handle spring 44 extends so that the handle 45 moves together with the bolt 42 in the −X axis direction relative to the retainer 4a. FIG. 12 illustrates this state. In this manner, the bolt 42 (handle 45) returns to a predetermined position by an elastic force of the handle spring 44 so that efficiency in exchanging rolled media R can be further enhanced. In the above description, the handle spring 44 is disposed between the retainer 4a and the handle 45. Alternatively, the handle spring 44 may be disposed between the retainer 4a and a spring bearing that moves together with the bolt 42.

In this embodiment, the side pressure mechanism 50 and the opening/closing mechanism 60 are provided in one of the pair of first holder units 3 as medium supports. The invention, however, is not limited to this example. The side pressure mechanism 50 and the opening/closing mechanism 60 may be provided in one or both of the pair of first holder units 3.

In the example described above, the side pressure mechanism 50 and the opening/closing mechanism 60 are provided in the first holder unit 3 of the feeder 26. Alternatively, the side pressure mechanism 50 and the opening/closing mechanism 60 may be provided in one or each of the second holder units 40 of the winder 37.

In the above description, each of the fitting spring 47, the arm spring 56, and the handle spring 44 uses the coil spring as an elastic member, but the present invention is not limited to this example. Each of the fitting spring 47, the arm spring 56, and the handle spring 44 may be made of a rubber that elastically deforms, for example.

As described above, the print apparatus 1 according to this embodiment can obtain the following advantages.

The first holder units 3 as a medium support of the print apparatus 1 includes the split-nut portion 54 and the opening/closing mechanism 60 for opening/closing the split-nut portion 54. When a side pressure to the rolled medium R held by the pair of first holder units 3 is canceled, the opening/closing mechanism 60 opens the split-nut portion 54 so that the split-nut portion 54 is unscrewed from the external screw portion 43 of the bolt 42. In this manner, the handle 45 fixed to the base 4 through the bolt 42 and the split-nut portion 54 becomes freely moveable along the X axis direction relative to the base 4. The user can return the handle 45 to a predetermined position (initial position for attaching the rolled medium R) without rotating the handle 45 so that efficiency in exchanging rolled media R can be enhanced. Thus, it is possible to provide the print apparatus 1 having enhanced efficiency in exchanging rolled media R.

The first holder unit 3 includes the handle spring 4 serving as an elastic member for returning the handle 45 to a predetermined position when the split-nut portion 54 is unscrewed from the external screw portion 43 of the bolt 42. The handle spring 44 compressed in applying a side pressure to the rolled medium R extends when the split-nut portion 54 is unscrewed from the external screw portion 43 of the bolt 42 so that the handle 4 moves together with the bolt 42 in the −X axis direction relative to the retainer 4a. In this manner, the handle 45 returns to a predetermined position by an elastic force of the handle spring 44 so that efficiency in exchanging rolled media R can be further enhanced.

The opening/closing mechanism 60 includes the opening/closing rollers 52a and 52b that are connected to the split-nut portion 54 and open and close the split-nut portion 54, the arm 51 that is engaged with the opening/closing rollers 52a and 52b and moves along the X axis direction to thereby open or close the opening/closing rollers 52a and 52b, and the arm spring 56 serving as an elastic member for moving the arm 51 in the X axis direction. When a side pressure to the rolled medium R held by the pair of first holder units 3 is canceled, the arm spring 56 moves the arm 51 in the −X axis direction relative to the base 4. In this manner, when the opening/closing rollers 52a and 52b move along the Y-shaped through groove 53 formed in the arm 51 from the open side of the Y-shape (+X axis side) to the closed side of the Y-shape (−X axis side) so that the opening/closing rollers 52a and 52b and the split-nut portion 54 are opened and the split-nut portion 54 is unscrewed from the external screw portion 43 of the bolt 42.

The present invention is not limited to the embodiment described above, and various changes and modifications may be made on the embodiment. Variations thereof will now be described.

### Variation

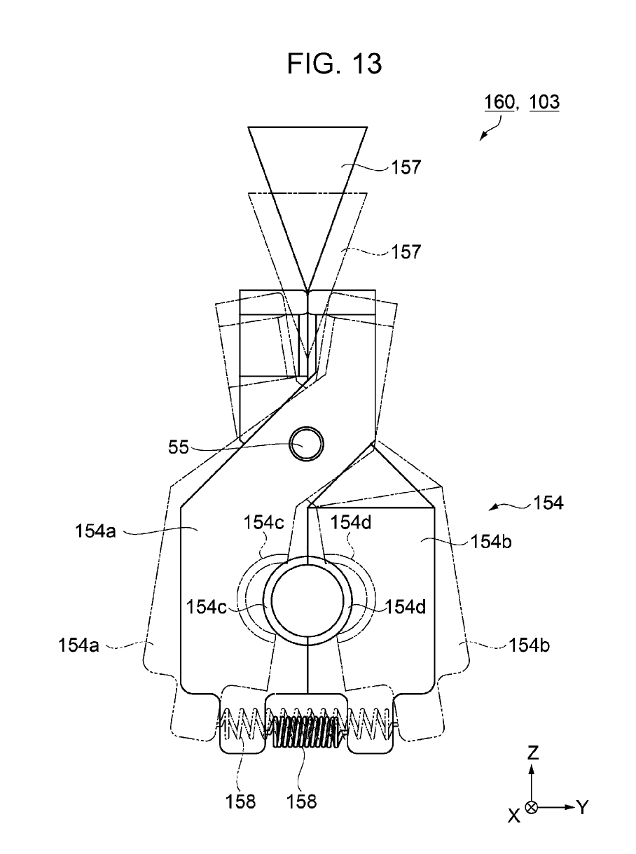

FIG. 13 is a side view illustrating a split-nut portion according to a variation in an enlarged manner.

In the embodiment, the opening/closing mechanism 60 includes the opening/closing rollers 52a and 52b that are connected to the split-nut portion 54 and open and close the split-nut portion 54 and the arm 51 that is engaged with the opening/closing rollers 52a and 52b and moves along the axial direction (X axis direction) to open or close the opening/closing rollers 52a and 52b. The invention, however, is not limited to this example.

A print apparatus 1 according to a variation will be described. Components already described in the embodiment are denoted by the same reference numerals, and description thereof will not be repeated.

As illustrated in FIG. 13, a first holder unit 103 includes a split-nut portion 154 that is provided on a base 4 and can be split into two parts. The split-nut portion 154 has a configuration in which a pair of stays 154a and 154b whose distal ends are engaged with each other are joined together by a fixing shaft 55 so that the distal ends can be opened and closed. The distal ends (−Z axis sides) of the stays 154a and 154b are provided with two nut pieces 154c and 154d that are split into two. The other ends of the pair of stays 154a and 154b are closed while the split-nut portion 154 is closed.

The first holder unit 103 includes an opening/closing mechanism 160 for opening/closing the split-nut portion 154. The opening/closing mechanism 160 includes a coil spring (hereinafter referred to as a split-nut spring 158) serving as an elastic member for keeping the split-nut portion 154 in the closed state, and a button 157 for opening the split-nut portion 154. An end of the split-nut spring 158 is connected to a distal end of the stay 154a, and the other end of the split-nut spring 158 is connected to a distal end of the stay 154b. The button 157 has a wedge shape having a distal end at the −Z axis side in a side view from the −X axis direction, and the distal end of the wedge shape faces downward (to the −Z axis side), and is located above and between the pair of stays 154a and 154b (at +Z axis side). The button 157 is moveable in the Z-axis direction.

When a user presses the button 157 in the −Z-axis direction, the other ends of the stays 154a and 154b are opened along the wedge shape of the button 157 so that the split-nut portion 154 is opened. In this manner, the split-nut portion 154 is unscrewed from the external screw portion 43 of the bolt 42 so that a handle 45 becomes freely moveable along the X axis direction relative to the base 4. The user can return the handle 45 to a predetermined position (initial position for attaching the rolled medium R) without rotating the handle 45 so that efficiency in exchanging rolled media R can be enhanced. When the user releases he/her hand from the button 157, an extended split-nut spring 158 is compressed so that the split-nut portion 154 is closed, and the button 157 returns to the original position. The opening/closing mechanism 160 according to this variation can be constituted by a small number of components including the button 157 and the split-nut spring 158. Thus, the opening/closing mechanism for opening/closing the split-nut portion 154 can be obtained at low costs.

In the above description, the split-nut spring 158 uses a coil spring as an elastic member. The invention, however, is not limited to this example. The split-nut spring 158 may be made of, for example, rubber that deforms elastically.

This application claims priority under 35 U.S.C. §119 to Japanese Patent Application No. 2015-243865, filed Dec. 15, 2015. The entire disclosure of Japanese Patent Application No. 2015-243865 is hereby incorporated herein by reference.

What is claimed is:

1. A print apparatus comprising a medium support that holds a rolled medium, wherein
the medium support includes
a base that moves along an axial direction of a guide rail and is fixed to the guide rail,
a main shaft that is supported on the base and moves along the axial direction to thereby fix the rolled medium,
a split-nut portion that is provided on the base and is splittable into two,
a bolt that moves the main shaft along the axial direction,
a handle that rotates the bolt axially, and
an opening/closing mechanism that opens and closes the split-nut portion, and
the split-nut portion is screwed onto the bolt and moves the bolt rotated with the handle along the axial direction while the split-nut portion is closed, and releases the bolt while the split-nut portion is open.

2. The print apparatus according to claim 1, further comprising an elastic member that returns the bolt to an initial position when the split-nut portion is unscrewed from the bolt.

3. The print apparatus according to claim 1, wherein
the opening/closing mechanism includes
an opening/closing roller that is connected to the split-nut portion and opens and closes the split-nut portion,
an arm that is engaged with the opening/closing roller and moves along the axial direction to thereby open or close the opening/closing roller, and
an elastic member that moves the arm along the axial direction.

4. The print apparatus according to claim 1, wherein
the opening/closing mechanism includes
an elastic member that keeps the split-nut portion closed, and
a button that opens the split-nut portion.
